(19) United States
(12) Patent Application Publication
(10) Pub. No.: US 2026/0061760 A1
(43) Pub. Date: Mar. 5, 2026

(54) THERMAL PRINTER

(71) Applicant: SEIKO EPSON CORPORATION, TOKYO (JP)

(72) Inventor: Ryota Nakamura, MATSUMOTO-SHI (JP)

(21) Appl. No.: 19/311,002

(22) Filed: Aug. 27, 2025

(30) Foreign Application Priority Data
Aug. 27, 2024 (JP) 2024-145261

(51) Int. Cl. B41J 15/04; B41J 2/32; B41J 11/00; B41J 11/04; B41J 11/14; B41J 29/17

(52) U.S. Cl. CPC B41J 15/04; B41J 2/32; B41J 11/0095; B41J 11/04; B41J 11/14; B41J 29/17

(57) ABSTRACT

A thermal printer includes a printing mechanism 200 having a thermal head 210 configured to perform printing on a recording paper S, and a platen roller 220 configured to transport the recording paper S nipped between the thermal head 210 and the platen roller and a friction mechanism 300 that is disposed on the upstream with respect the printing mechanism 200 in a transport direction of the recording paper S and that apply friction to a printing surface S1 of the recording paper S.

The present application is based on, and claims priority from JP Application Serial Number 2024-145261, filed Aug. 27, 2024, the disclosure of which is hereby incorporated by reference herein in its entirety.

### BACKGROUND

### 1. Technical Field

The present disclosure relates to a thermal printer.

### 2. Related Art

JP-A-2017-35803 discloses a thermal printer in which a recording paper is held between a thermal head and a platen roller. The thermal head is biased toward the platen roller.

However, the configuration described in JP-A-2017-35803 has a problem that, when hard foreign matter is present on the printing surface of the recording paper, the thermal head is likely to be worn due to contact between the thermal head and the hard foreign matter.

### SUMMARY

A thermal printer includes a printing mechanism including a thermal head configured to perform printing on a recording paper and a platen roller configured to transport the recording paper nipped between the thermal head and the platen roller and a friction mechanism that is disposed upstream with respect to the printing mechanism in a transport direction of the recording paper and that is configured to apply friction to a printing surface of the recording paper.

### BRIEF DESCRIPTION OF THE DRAWINGS

FIG. 1 is a cross-sectional view showing a configuration of a thermal printer.

FIG. 2 is a cross-sectional view showing a configuration of the thermal printer.

FIG. 3A is a cross-sectional view showing the configuration of a friction mechanism and a printing mechanism.

FIG. 3B is an enlarged cross-sectional view of a section A in FIG. 3A.

FIG. 3C is an enlarged cross-sectional view of a section B in FIG. 3A.

FIG. 4 is a cross-sectional view showing a configuration of the thermal printer of the present embodiment.

FIG. 5 is a cross-sectional view showing a configuration of a thermal printer according to a modification.

FIG. 6 is a cross-sectional view showing a configuration of a thermal printer according to a modification.

### DESCRIPTION OF EMBODIMENTS

Hereinafter, the configuration of a thermal printer 1000 will be described with reference to the drawings. In each of the following drawings, three axes orthogonal to each other are described as an X-axis, a Y-axis, and a Z-axis. A direction along the X-axis is referred to as an “X direction”, a direction along the Y-axis is referred to as a “Y direction”, a direction along the Z-axis is referred to as a “Z direction”, a direction indicated by an arrow is referred to as a + direction and a direction opposite to the + direction is referred to as a − direction.

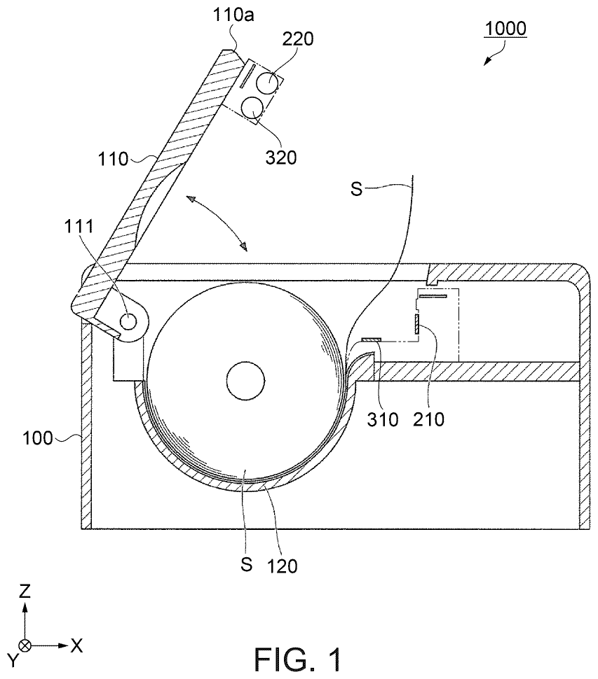

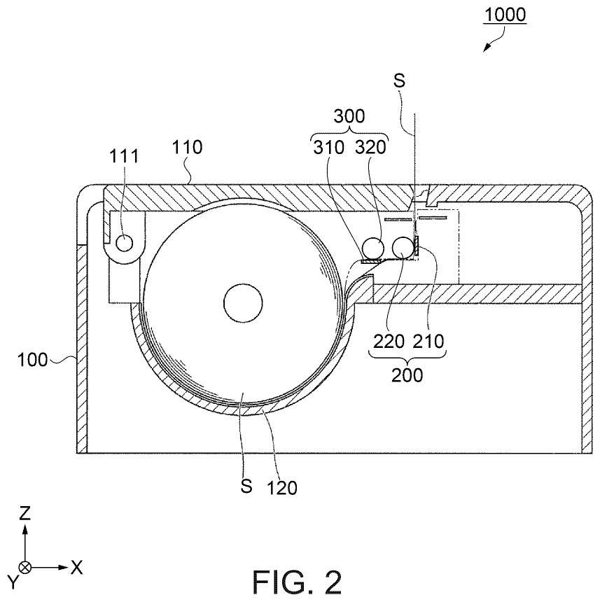

First, the configuration of the thermal printer 1000 will be described with reference to FIG. 1 and FIG. 2. FIG. 1 shows a state in which a cover 110 is open with respect to a device main body 100.

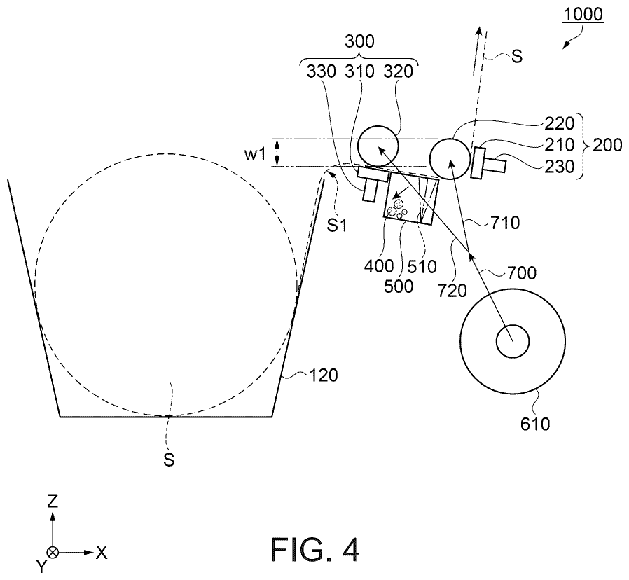

As shown in FIG. 1, the thermal printer 1000 is applied to a receipt printer used in a POS system, for example. For example, the thermal printer 1000 performs printing on a roll-shaped recording paper S by a thermal head 210 (see FIG. 4) of a thermal type.

The thermal printer 1000 includes the device main body 100 and the cover 110. A recording paper accommodation section 120 is disposed on the left side of the device main body 100, that is, in the −X direction. The recording paper accommodation section 120 accommodates the roll-shaped recording paper S.

The cover 110 is attached so as to be pivotable around a support shaft 111 provided at an upper end section of the device main body 100, that is, so as to be openable and closable. A platen roller 220 is disposed at a distal end 110a of the cover 110. When the cover 110 is closed to the device main body 100, the platen roller 220 and the thermal head 210 are brought into contact with each other (see FIG. 2).

A printing mechanism 200 has the thermal head 210 and the like is disposed in the center of the device main body 100. The printing mechanism 200 has the thermal head 210 that performs printing on the recording paper S and the platen roller 220 that transports the recording paper S that is nipped between the thermal head 210 and the platen roller.

As shown in FIG. 2, a friction mechanism 300 is disposed upstream of the printing mechanism 200 in a transport direction of the recording paper S (see FIG. 4).

The friction mechanism 300 applies friction to a printing surface of the recording paper S. The friction mechanism 300 includes an opposing member 310 and a rotating roller 320. The opposing member 310 contacts the printing surface of the recording paper S. The rotating roller 320 nips the recording paper S between itself and the opposing member 310.

The opposing member 310 and the rotating roller 320 are such that at least one of the opposing member 310 and the rotating roller 320 is pressing toward the other. In the present embodiment, the opposing member 310 presses toward the rotating roller 320.

The opposing member 310 has a hardness equal to or higher than that of the thermal head 210. Examples of the opposing member 310 include a silica-based film, a plate-like member, and a member obtained by providing a silica-based film on a plate-like member. The opposing member 310 has a shape that can uniformly press the recording paper S in the width direction without omission against a pressure contact line (or surface) with the rotating roller 320.

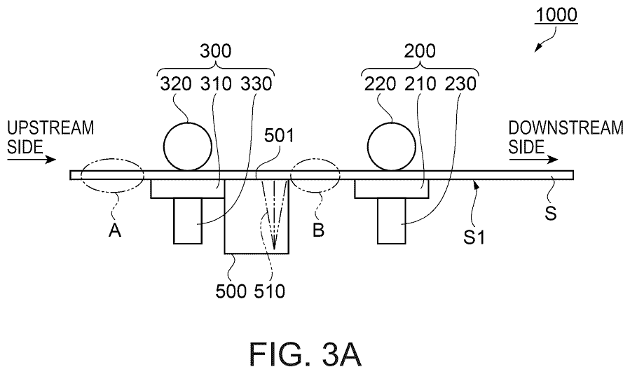

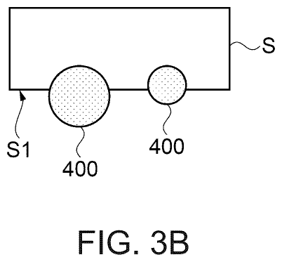

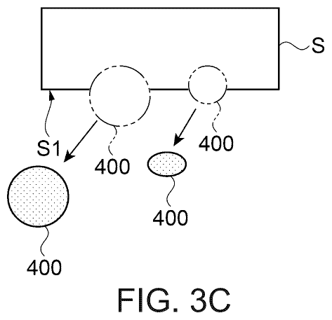

In this way, since the friction mechanism 300 is disposed on the upstream side of the printing mechanism 200, even when hard foreign matter 400 (see FIG. 3B) is present on the printing surface of the recording paper S, the foreign matter 400 is applied with friction by the friction mechanism 300, and thus, it is possible to scrape off the portion of the foreign matter 400 that protrudes from the printing surface S1 or to remove the foreign matter 400 (see FIG. 3C). Therefore, it is possible to suppress contact between the thermal head 210 and the foreign matter 400, and it is possible to suppress acceleration of wear of the thermal head 210.

At least one of the opposing member 310 and the rotating roller 320 presses toward the other. Specifically, in the present embodiment, the opposing member 310 biases toward the rotating roller 320. Therefore, even when the hard foreign matter 400 is present on the printing surface of the recording paper S, the portion of the foreign matter 400 protruding from the printing surface S1 can be scraped off or the foreign matter 400 can be removed by friction between the opposing member 310 and the printing surface of the recording paper S.

The platen roller 220 and the rotating roller 320 are rotatably attached to the cover 110. When the cover 110 is opened with respect to the device main body 100, the platen roller 220 and the rotating roller 320 lift up together. Accordingly, the recording paper S is released from the nipped state, and the recording paper S is easily replaced. That is, the ease of replacement of the recording paper S can be ensured.

Next, the configuration of the printing mechanism 200 and the friction mechanism 300, and the relationship therebetween will be described with reference to FIG. 3A to FIG. 3C. The thermal printer 1000 shown in FIG. 3A is a drawing for explaining the principles of the printing mechanism 200 and the friction mechanism 300, and the printing mechanism 200 and the friction mechanism 300 are described as being at the same height.

As shown in FIG. 3A, in the thermal printer 1000, the friction mechanism 300 is disposed on the upstream side in the transport direction of the recording paper S, and the printing mechanism 200 is disposed on the downstream side.

As described above, the printing mechanism 200 has the thermal head 210 that performs printing on the recording paper S, the platen roller 220 that transports the recording paper S nipped between the thermal head 210 and the platen roller 220, and a first pressing member 230 as a pressing member that presses the thermal head 210 toward the platen roller.

The thermal head 210 is movably supported by the device main body 100. The thermal head 210 includes a head unit in which a head is attached to a head attachment member. The thermal head 210 may be configured to be movable in a direction approaching and separating from the platen roller 220 by being configured to be rotatable or slidable by providing a support shaft, for example. The platen roller 220 is disposed so as to face the thermal head 210. The platen roller 220 is, for example, composed of a cylindrical rubber roller. The platen roller 220 is rotatably supported by the cover 110 via a platen frame (not shown).

The first pressing member 230 is, for example, a coil spring. The first pressing member 230 is disposed on the opposite side of the thermal head 210 than the platen roller 220. The first pressing member 230 is in contact with the thermal head 210. The first pressing member 230 presses the thermal head 210 toward the platen roller 220.

The recording paper S passes between the platen roller 220 and the thermal head 210. The platen roller 220 and the thermal head 210 are configured to nip the recording paper S with a predetermined pressure. The recording paper S is transported by the rotation of the platen roller 220.

The friction mechanism 300 is disposed upstream with respect to the printing mechanism 200 in the transport direction of the recording paper S. The friction mechanism 300 applies friction to the printing surface S1 of the recording paper S.

The friction mechanism 300 has the opposing member 310 that contacts the printing surface S1 of the recording paper S, the rotating roller 320 that nips the recording paper S between the opposing member 310 and the rotating roller 320, and a second pressing member 330 as a pressing member that presses the opposing member 310 toward the rotating roller.

The opposing member 310 is movably supported by the device main body 100. The opposing member 310 may be configured to be movable in a direction approaching and separating from the rotating roller 320 by being configured to be rotatable or slidable by providing a support shaft, for example. The rotating roller 320 is disposed so as to face the opposing member 310. The rotating roller 320 is, for example, composed of a cylindrical rubber roller. The rotating roller 320 is rotatably supported by the cover 110 via a frame (not shown).

The second pressing member 330 is, for example, a coil spring. The second pressing member 330 is disposed on the opposite side of the opposing member 310 with respect to the rotating roller 320. The second pressing member 330 is in contact with the opposing member 310. The second pressing member 330 presses the opposing member 310 toward the rotating roller 320.

The recording paper S passes between the rotating roller 320 and the opposing member 310. The rotating roller 320 and the opposing member 310 are configured to nip the recording paper S with a predetermined pressure. The recording paper S is transported by the rotation of the rotating roller 320.

The platen roller 220 of the printing mechanism 200 and the rotating roller 320 of the friction mechanism 300 may be the same parts. The first pressing member 230 of the printing mechanism 200 and the second pressing member 330 of the friction mechanism 300 may be the same parts.

In this way, the friction mechanism 300 is disposed upstream of the printing mechanism 200, the recording paper S is nipped between the opposing member 310 and the rotating roller 320, and the opposing member 310 applies friction to the printing surface S1 of the recording paper S. Therefore, as shown in FIG. 3B, even when hard foreign matter 400 is present on the printing surface S1 of the recording paper S, the foreign matter 400 is applied with friction by the friction mechanism 300, that is, the opposing member 310, and thus, it is possible to scrape the portion of the foreign matter 400 protruding from the printing surface S1 or remove the foreign matter 400 (see FIG. the 3C). Therefore, in the printing mechanism 200 disposed downstream of the friction mechanism 300, it is possible to suppress contact between the thermal head 210 and the foreign matter 400, and it is possible to suppress acceleration of wear of the thermal head 210.

Since the opposing member 310 is pressed toward the rotating roller 320, it is possible to apply a force to the printing surface S1 of the recording paper S, and it is possible to scrape off the portion of the foreign matter 400 protruding from the printing surface S1 or remove the foreign matter 400 by the movement of the recording paper S.

Since the platen roller 220 and the rotating roller 320 are the same part and the first pressing member 230 and the second pressing member 330 are the same part, it is possible to suppress an increase in the number of types of parts and to suppress the cost. Further, by using the same parts, it is possible to suppress variation in the pressing force to the recording paper S. Therefore, in the friction mechanism 300, it is possible to suppress deterioration of the recording paper S.

A foreign matter collection section 500 that collects the foreign matter 400 removed from the recording paper S is disposed between the friction mechanism 300 and the printing mechanism 200 in the transport direction. An opening section 501 of the foreign matter collection section 500 is disposed so as to face the printing surface S1 of the recording paper S. A broom 510 for removing the foreign matter 400 is disposed in the foreign matter collection section 500. The distal end of the broom 510 is in contact with the printing surface S1 of the recording paper S.

By contacting the distal end of the broom 510 to the recording paper S, the hard foreign matter 400 adhering to the recording paper S can be removed. The removed foreign matter 400 is collected by the foreign matter collection section 500. The recording paper S that has passed through the foreign matter collection section 500 has the foreign matter 400 removed. Alternatively, the protruding portion of the foreign matter 400 is polished and flattened. The foreign matter 400 adhering to the recording paper S by static electricity is removed by contacting with the broom 510 disposed in the foreign matter collection section 500. Note that as the broom 510, for example, a static elimination brush is exemplified.

In this way, the foreign matter collection section 500 is disposed in this manner, the foreign matter 400 removed from the recording paper S can be collected, and the foreign matter 400 can be prevented from scattering inside the thermal printer 1000. Therefore, an abnormal value detection by an optical sensor 800 inside the thermal printer 1000 and failure of an internal mechanism including the optical sensor 800 can be suppressed.

Next, the configuration of the thermal printer 1000 will be described with reference to FIG. 4.

As shown in FIG. 4, the thermal printer 1000 has the roll-shaped recording paper S, the friction mechanism 300 that nips and transports the recording paper S downstream, and the printing mechanism 200. The roll-shaped recording paper S is provided in the recording paper accommodation section 120.

The friction mechanism 300 is disposed upstream of the printing mechanism 200 in the transport direction of the recording paper S. The friction mechanism 300 removes the foreign matter 400 included in the recording paper S by applying friction to the printing surface S1 of the recording paper S. As described above, the friction mechanism 300 has the opposing member 310 that contacts the printing surface S1 of the recording paper S, the rotating roller 320 that nips the recording paper S between the opposing member 310 and the rotating roller 320, and the second pressing member 330 that presses the opposing member 310 toward the rotating roller.

As described above, the printing mechanism 200 has the thermal head 210 that prints on the printing surface S1 of the recording paper S, the platen roller 220 that transports the recording paper S nip between the thermal head 210 and the platen roller 220, and the first pressing member 230 that presses the thermal head 210 toward the platen roller.

In the friction mechanism 300, the opposing member 310 and the second pressing member 330 are disposed in the −Z direction with respect to the rotating roller 320. In the printing mechanism 200, the thermal head 210 and the first pressing member 230 are disposed in the +X direction with respect to the platen roller 220. Note that the opposing member 310, the second pressing member 330, the thermal head 210, and the first pressing member 230 are not limited to being disposed in the above described directions, and may be appropriately changed according to the transport direction of the recording paper S.

The platen roller 220 and the rotating roller 320 are rotated by the drive of a drive motor 610. The drive motor 610 is connected to a transmission mechanism 700. The transmission mechanism 700 is connected to a first transmission mechanism 710 connected to the platen roller 220 and a second transmission mechanism 720 connected to the rotating roller 320. That is, the drive motor 610 drives rotation of the platen roller 220 and the rotating roller 320 via the transmission mechanisms 700, 710, and 720. The transmission mechanisms 700, 710, and 720 are, for example, gears.

Since the platen roller 220 and the rotating roller 320 are driven by the drive motor 610, the platen roller 220 and the rotating roller 320 can be rotated at the same speed. In this way, the platen roller 220 and the rotating roller 320 are driven by the single drive motor 610, and thus can be efficiently driven with a small number of parts.

The rotating roller 320 and the platen roller 220 are disposed so at least a portion w1 overlaps as viewed in the first direction, in other words, the X direction. In this way, because the rotating roller 320 and the platen roller 220 are disposed so that a portion w1 overlaps, the thermal printer 1000 can be prevented from becoming larger in size compared to when they are not disposed to overlap. The first direction is not limited to the X direction, and in order to discharge the recording paper S from the thermal printer 1000 in a horizontal direction, for example, when the thermal printer 1000 is installed with the side surface (the + direction of the X-axis) of the device main body 100 upward, at least the portion w1 overlaps with each other as viewed in the Z direction.

The foreign matter collection section 500 that collects the foreign matter 400 removed from the recording paper S is disposed between the friction mechanism 300 and the printing mechanism 200. The broom 510 for removing the foreign matter 400 is disposed in the foreign matter collection section 500.

As described above, the thermal printer 1000 of the present embodiment includes the printing mechanism 200 including the thermal head 210 that performs printing on the recording paper S and the platen roller 220 that transports the recording paper S nipped between the thermal head 210 and the platen roller, and the friction mechanism 300 that is disposed upstream of the printing mechanism 200 in the transport direction of the recording paper S and that applies friction to the printing surface S1 of the recording paper S.

According to this configuration, since the friction mechanism 300 is disposed on the upstream side of the printing mechanism 200, even when the hard foreign matter 400 is present on the printing surface S1 of the recording paper S, the friction mechanism 300 applies friction to the foreign matter 400, and thus, it is possible to scrape off the portion of the foreign matter 400 protruding from the printing surface S1 or to remove the foreign matter 400. Therefore, it is possible to suppress contact between the thermal head 210 and the foreign matter 400, and it is possible to suppress acceleration of wear of the thermal head 210.

Since acceleration of wear of the thermal head 210 is suppressed, it is possible to suppress damage to the thermal head 210, and it is possible to extend the product life. Since the two rollers, that is, the rotating roller 320 and the platen roller 220, are attached to the cover 110, the recording paper S can be easily replaced by merely opening the cover 110.

In the thermal printer 1000 of the present embodiment, it is desirable that the friction mechanism 300 includes the opposing member 310 that contacts the printing surface S1 of the recording paper S, and the rotating roller 320 that nips the recording paper S between the opposing member 310, and that at least one of the opposing member 310 and the rotating roller 320 presses against the other. According to this configuration, since the opposing member 310 and the rotating roller 320 are biased in the directions of each other, even when the hard foreign matter 400 is present on the printing surface S1 of the recording paper S, it is possible to scrape off the portion of the foreign matter 400 protruding from the printing surface S1 or to remove the foreign matter 400 by friction between the opposing member 310 and the printing surface S1 of the recording paper S.

In the thermal printer 1000 according to the present embodiment, the friction mechanism 300 desirably has the second pressing member 330 that presses the opposing member 310, and the second pressing member 330 desirably presses the rotating roller 320 via the opposing member 310. According to this configuration, since the opposing member 310 is pressed toward the rotating roller 320, it is possible to apply a force to the printing surface S1 of the recording paper S, and it is possible to scrape off the portion of the foreign matter 400 protruding from the printing surface S1, or to remove the foreign matter 400, by the movement of the recording paper S.

In the thermal printer 1000 of the present embodiment, the rotating roller 320 is desirably the same part as the platen roller 220, and the second pressing member 330 is desirably the same part as the first pressing member 230 that presses the thermal head 210 to the platen roller 220. According to this configuration, since the rotating roller 320 and the platen roller 220 are the same part and the second pressing member 330 is the same part as the first pressing member 230, it is possible to suppress an increase in the number of types of parts and to suppress the cost. Further, by using the same parts, it is possible to suppress variation in the pressing force to the recording paper S. Therefore, in the friction mechanism 300, it is possible to suppress deterioration of the recording paper S.

In the thermal printer 1000 of the present embodiment, it is desirable that the foreign matter collection section 500 that collects the foreign matter 400 included in the recording paper S is disposed between the friction mechanism 300 and the printing mechanism 200 in the transport direction, and that the foreign matter collection section 500 is disposed so as to face the printing surface S1 of the recording paper S. According to this configuration, since the foreign matter collection section 500 is disposed, the foreign matter 400 removed from the recording paper S can be collected, and the foreign matter 400 can be prevented from scattering inside the thermal printer 1000. As a result, the thermal printer 1000 can be prevented from failing or malfunctioning.

In the thermal printer 1000 of the present embodiment, it is desirable that at least a part of the rotating roller 320 and the platen roller 220 are disposed so as to overlap with each other at w1 as viewed in the horizontal direction. According to this configuration, since the rotating roller 320 and platen roller 220 are disposed overlapping each other in this configuration, an increase in the size of the thermal printer 1000 can be suppressed compared to when they are not disposed overlapping each other.

The thermal printer 1000 according to the present embodiment desirably also includes the drive motor 610 and the transmission mechanisms 700, 710, and 720 connected to the drive motor 610, and the drive motor 610 drives the platen roller 220 and the rotating roller 320 via the transmission mechanisms 700, 710, and 720. According to this configuration, the platen roller 220 and the rotating roller 320 are driven by the single drive motor 610, and thus can be efficiently driven with a small number of parts.

Hereinafter, a modification of the above described embodiment will be described.

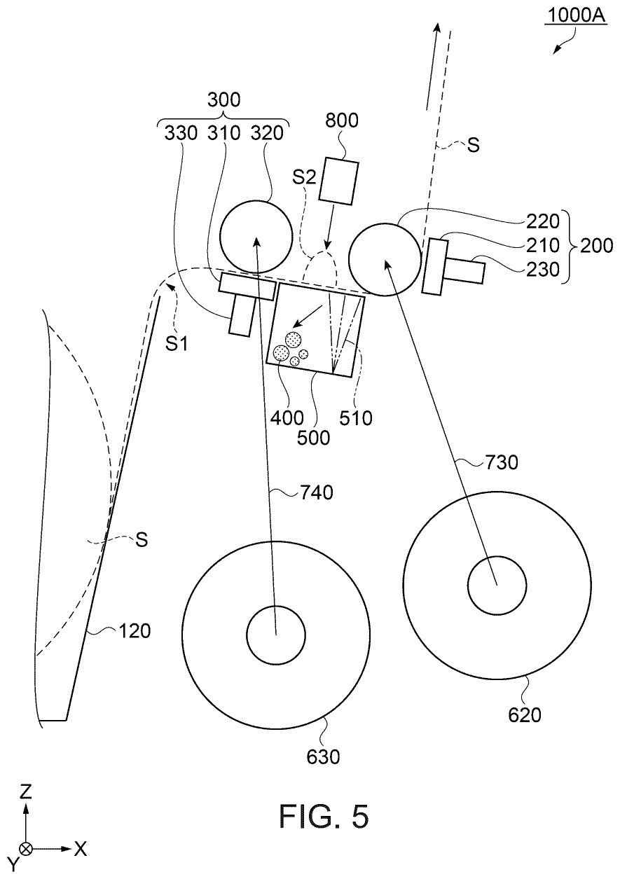

As described above, it is not limited to the configuration in which the rotating roller 320 and the platen roller 220 are driven by one drive motor 610, and the configuration shown in FIG. 5 may be adopted. As shown in FIG. 5, a thermal printer 1000A of the modification has a first drive motor 620 that drives the platen roller 220 and a second drive motor 630 that drives the rotating roller 320. That is, the platen roller 220 and the rotating roller 320 are driven by separate drive motors 620 and 630.

The first drive motor 620 drives the platen roller 220 via a first transmission mechanism 730. The second drive motor 630 drives the rotating roller 320 via a second transmission mechanism 740. The first transmission mechanism 730 and the second transmission mechanism 740 are, for example, gears as described above.

In this way, since the platen roller 220 and the rotating roller 320 are driven by the separate drive motors 620 and 630, it is possible to disperse the transport force and to reduce the paper feed load of the platen roller 220 compared to a method of transporting the recording paper S by one of the platen roller 220.

Since the recording paper S is transported by the separate drive motors 620 and 630, it is possible to provide slack S2 in the recording paper S between the rotating roller 320 and the platen roller 220. Therefore, as shown in FIG. 5, it is desirable that the optical sensor 800 as a sensor for detecting the slack amount of the recording paper S is disposed between the friction mechanism 300 and the printing mechanism 200.

In this way, since the optical sensor 800 that detects the slack amount of the recording paper S is disposed, when the slack amount is smaller than a predetermined slack amount, the slack amount can be increased by increasing the rotation speed of the rotating roller 320. When the slack amount is larger than the predetermined slack amount, the slack amount can be reduced by slowing the rotation of the rotating roller 320. Therefore, the slack amount can be kept constant, and the paper feed load by the platen roller 220 can be reduced.

As described above, the thermal printer 1000A of the present modification includes the first drive motor 620 that drives the platen roller 220 and the second drive motor 630 that drives the rotating roller 320. According to this configuration, since the platen roller 220 and the rotating roller 320 are driven by the separate drive motors 620 and 630, it is possible to disperse the transport force and to reduce the paper feed load on the platen roller 220 compared to a method of transporting the recording paper S by a single platen roller 220. Since the recording paper S is transported by the separate drive motors 620 and 630, it is possible to provide slack S2 between the rotating roller 320 and the platen roller 220. That is, the rotating roller 320 functions as a feeding mechanism. It is possible to reduce the required performance of the first drive motor 620 that drives the platen roller 220.

In the thermal printer 1000A of the present modification, the optical sensor 800 that detects the slack amount of the recording paper S is desirably disposed between the friction mechanism 300 and the printing mechanism 200. According to this configuration, since the optical sensor 800 that detects the slack amount of the recording paper S is disposed, when the slack amount is smaller than a predetermined slack amount, the slack amount can be increased by increasing the rotation speed of the rotating roller 320, and when the slack amount is larger than the predetermined slack amount, the slack amount can be reduced by decreasing the rotation speed of the rotating roller 320. Therefore, the slack amount can be kept constant, and the paper feed load by the platen roller 220 can be reduced.

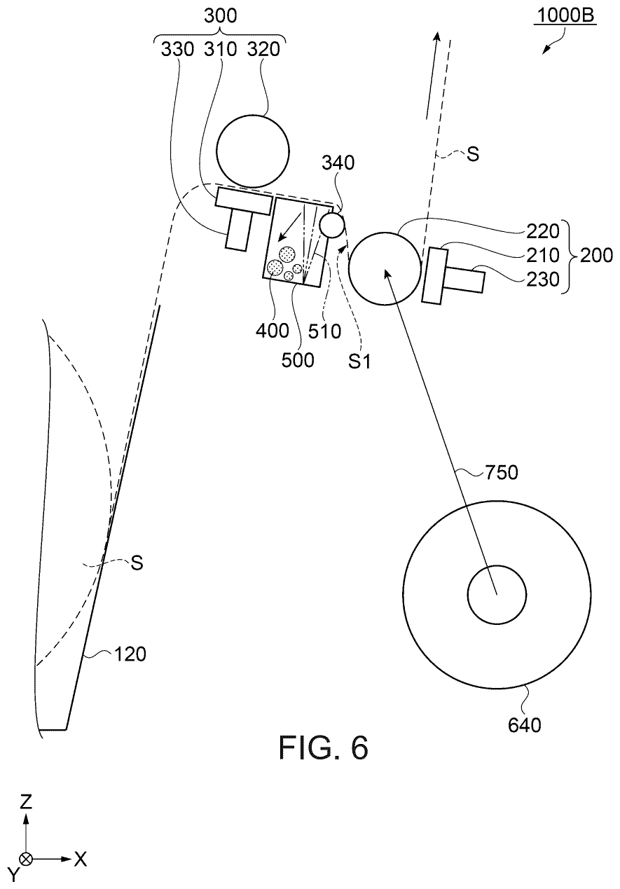

As described above, it is not limited to driving the rotating roller 320 using the drive motor 610, and as shown in FIG. 6, the drive motor 610 may not be used and the rotating roller 320 may not be driven. As shown in FIG. 6, a thermal printer 1000B of the modification drives the platen roller 220 using a drive motor 640. Specifically, the drive motor 640 drives the platen roller 220 via a transmission mechanism 750.

The position of the platen roller 220 is lower than the position of the rotating roller 320, that is, disposed in the −Z direction. Therefore, the positions of the thermal head 210 and the first pressing member 230 are also disposed in the −Z direction. A driven roller 340 that supports the printing surface S1 of the recording paper S is disposed between the friction mechanism 300 and the printing mechanism 200. The position of the driven roller 340 is the same as the height of the opposing member 310. That is, the position of the platen roller 220 is lower than the position of the driven roller 340.

In this way, since the position of the platen roller 220 is disposed below the position of the driven roller 340, the recording paper S winds around the driven roller 340. Accordingly, the recording paper S winds around the platen roller 220 over approximately half its circumference. That is, it is possible to increase the contact area between the platen roller 220 and the recording paper S, and the frictional force increases, and thus it is possible to increase the transporting force of the recording paper S by the platen roller 220. It is possible to suppress a loss of power from the drive motor 640.

As described above, the thermal printer 1000B of the present modification includes the drive motor 640 that drives the platen roller 220, and the rotating roller is configured as the driven roller 340. This configuration enables the thermal printer 1000B to be configured with a small number of parts. This allows space saving to be achieved at a low cost.

As described above, in the thermal printer 1000B of the present modification, the driven roller 340 that supports the printing surface S1 of the recording paper S is disposed between the friction mechanism 300 and the printing mechanism 200. According to this configuration, by disposing the driven roller 340 and the platen roller 220 so that the recording paper S winds around the driven roller 340, it is possible to increase the contact area between the platen roller 220 and the recording paper S, and it is possible to increase the transporting force of the recording paper S by the platen roller 220.

As described above, the friction mechanism 300 and the printing mechanism 200 are not limited to being applied to a receipt printer, and may be applied to a label printer, for example.

As described above, the friction mechanism 300 is not limited to the configuration in which the opposing member 310 is disposed on the lower side with respect to the recording paper S, that is, in the −Z direction, and may be disposed on the upper side with respect to the recording paper S, that is, in the +Z direction. The rotating roller 320 is dedicatedly used for the opposing member 310, but this is not limiting, and the opposing member 310 may be disposed so that the platen roller 220 of the printing mechanism 200 can be commonly used.

As described above, the sensor is not limited to the optical sensor 800, and may be, for example, a contact type sensor.

What is claimed is:

1. A thermal printer comprising:
a printing mechanism including a thermal head configured to perform printing on a recording paper and a platen roller configured to transport the recording paper nipped between the thermal head and the platen roller and
a friction mechanism that is disposed upstream with respect to the printing mechanism in a transport direction of the recording paper and that is configured to apply friction to a printing surface of the recording paper.

2. The thermal printer according to claim 1, wherein
the friction mechanism includes an opposing member configured to contact the printing surface of the recording paper, and a rotating roller configured to hold the recording paper between the opposing member and the rotating roller and
at least one of the opposing member and the rotating roller press towards the other.

3. The thermal printer according to claim 2, wherein
the friction mechanism includes a pressing member configured to press the opposing member and
the pressing member is configured to press the rotating roller via the opposing member.

4. The thermal printer according to claim 3, wherein
the rotating roller is the same part as the platen roller and
the pressing member is the same part as the pressing member that presses the thermal head against the platen roller.

5. The thermal printer according to claim 1, wherein
a foreign matter collection section configured to collect a foreign matter included in the recording paper is disposed between the friction mechanism and the printing mechanism in the transport direction and
the foreign matter collection section is disposed so as to face the printing surface of the recording paper.

6. The thermal printer according to claim 2, wherein
the rotating roller and the platen roller are disposed so as to at least partially overlap each other as viewed in a first direction.

7. The thermal printer according to claim 2, further comprising:
a drive motor configured to drive the platen roller, wherein
the rotating roller is configured as a driven roller.

8. The thermal printer according to claim 2, further comprising:
a drive motor and a transmission mechanism connected to the drive motor, wherein
the drive motor is configured to drive the platen roller and the rotating roller.

9. The thermal printer according to claim 2, further comprising:
a first drive motor configured to drive the platen roller and
a second drive motor configured to drive the rotating roller.

10. The thermal printer according to claim 9, wherein
a sensor configured to detect a slack amount of the recording paper is disposed between the friction mechanism and the printing mechanism.

11. The thermal printer according to claim 1, wherein
a driven roller configured to support the printing surface of the recording paper is disposed between the friction mechanism and the printing mechanism.
